(19) United States
(12) Patent Application Publication
(10) Pub. No.: US 2008/0088759 A1
(43) Pub. Date: Apr. 17, 2008

(54) Liquid Crystal Display Device

(76) Inventors: Yuka Utsumi, Hitachi (JP); Ikuo Hiyama, Hitachinaka (JP); Daisuke Kajita, Hitachi (JP); Kikuo Ono, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/865,755

(22) Filed: Oct. 2, 2007

(30) Foreign Application Priority Data
Oct. 2, 2006 (JP) 2006-270526
Oct. 2, 2006 (JP) 2006-270527

(51) Int. Cl. G02F 1/1335; G02F 1/1368

(52) U.S. Cl. 349/42; 349/106; 349/62; 349/96

(57) ABSTRACT

There is provided a liquid crystal display device capable of minimizing a difference in hue between a black state and a white state to provide high-quality display. The liquid crystal display device includes: a first substrate and a second substrate; a liquid crystal layer disposed between the first and second substrates; a first electrode provided on the first substrate and a second electrode which applies an electric field to the liquid crystal layer by an electric potential difference produced between the first electrode and the second electrode; and color filters provided on the first substrate or the second substrate; wherein the liquid crystal layer has a property of changing from an optically isotropic state to an optically anisotropic state in response to application of a voltage; and the color filters are made of a dye material.

### BACKGROUND OF THE INVENTION

(1) Field of the Invention

The present invention relates to a liquid crystal display device and, in particular, to a liquid crystal display device a so-called in-plane switching mode liquid crystal display device.

(2) Description of Related Art

When a liquid crystal display device is used as a television monitor, it is desirable that the liquid crystal display device should have good wide viewing angle characteristics.

A liquid crystal display device called an in-plane switching mode liquid crystal display device can provide a wider viewing angle than conventional twisted nematic (TN) mode liquid crystal displays, for example.

An in-plane switching mode liquid crystal display device has a pair of electrodes in each pixel region on a surface of one of opposed substrates containing a liquid crystal layer between them that faces the liquid crystal layer. Behavior of liquid crystal molecules responsive to an electric field generated by an electric potential difference applied to these electrodes causes light incident on the liquid crystal layer to be output at a wider angle, thereby providing the wider viewing angle.

The conventional in-plane switching mode liquid crystal display devices use an optically uniaxial liquid crystal material.

However, liquid crystal materials that are optically isotropic, called isotropic liquid crystals, have become known in recent years.

The molecules of these liquid crystals are three- or two-dimensionally optically isotropic when no voltage is applied to the liquid crystal layer. When a voltage is applied, birefringence is induced in the direction of application of the voltage.

Such an isotropic liquid crystal is detailed in JP-A-2006-3840, for example.

Because conventional in-plane switching mode liquid crystal display devices use an optically uniaxial liquid crystal material as mentioned above, their viewing angles depend on transmittance. In addition, it has been shown that, when an image is displayed in a black state in the absence of a voltage (normally black), the contrast ratio is inevitably reduced by light leakage depending on light scattering due to thermal fluctuations of the liquid crystal.

Therefore, the present applicant solved the problem by using an isotropic liquid crystal material in an in-plane switching mode liquid crystal display device.

However, it has been revealed that the difference in hue between a black state and a white state is remarkably increased in a liquid crystal display device that uses such an isotropic liquid crystal material.

FIG. 10A is a graph of spectral radiance in a black state in a liquid crystal display device; FIG. 10B is a graph of spectral radiance in a white state in the liquid crystal display device. In either graph, the horizontal axis represents wavelength (in nm) and the vertical axis represents the intensity of the spectrum. The spectral radiances of blue (B), green (G), and red (R) are shown, from the left to right in the graphs.

Since the chromaticity (color temperature) specifications for a white state of television or monitors are predetermined, the spectrum radiance in the white state has a characteristic as shown in FIG. 10B.

Comparing FIG. 10A with FIG. 10B, it can be seen from the portion in the dashed circle α that a bluish tone is intensified in the black state. The difference in hue of the black state from the white state is increased and the color purities of red (R) and green (G) at low gray levels are significantly decreased by the bluish tone.

This phenomenon occurs as follows. The so-called retardation in the black state when a voltage is not applied is nearly zero and therefore the hue of the black state appears as a spectral radiance caused by scattering at the color filters whereas the hue of the white state appears as a spectral radiance represented by the retardation in the liquid crystal layer and the transmittance of the color filters. The difference between the spectral radiances shows up as the phenomenon.

The retardation is the product Δnd of the difference Δn (anisotropy refractive index) between the extraordinary refractive index and the ordinary refractive index and the thickness of the liquid crystal layer “d”. Curve “a” in the graph shown in FIG. 11 represents the spectral transmittance in the black state described above and curve “b” represents the spectral transmittance in the white state described above. The intensity of the spectral transmittance along the y-axis on the right-hand side of the graph corresponds to the curve “a” and the intensity of the spectral transmittance along the y-axis on the left-hand side corresponds to the curve “b” in FIG. 11.

The problem is that, when an isotropic liquid crystal is used, the difference in hue of the black state from the white state is notably increased primarily by scattering caused by the color filters without the influence of scattering in the liquid crystal in the black state.

An object of the present invention is to provide a liquid crystal display device capable of minimizing the difference in hue between the black and white states and providing high-quality display having further increased viewing angle characteristics with a simple and inexpensive configuration.

Other objects, features and advantages of the invention will become apparent from the following description of the embodiments of the invention taken in conjunction with the accompanying drawings.

### BRIEF SUMMARY OF THE INVENTION

Typical aspects of the present invention disclosed herein will be briefly summarized below.

(1) A liquid crystal display according to the present invention includes, for example:

a first substrate and a second substrate;

a liquid crystal layer disposed between the first and second substrates;

a first electrode provided on the first substrate and a second electrode which applies an electric field to the liquid crystal layer by an electric potential difference produced between the first electrode and the second electrode; and

color filters provided on the first substrate or the second substrate;

wherein the liquid crystal layer has a property of changing from an optically isotropic state to an optically anisotropic state in response to application of a voltage; and

the color filters are made of a dye material.

(2) The liquid crystal display device according to the present invention has the configuration described in (1), for example, wherein the dye material is a photosensitive material.

(3) The liquid crystal display device according to the present invention has the configuration described in (1), for example, wherein a red color filter and a green color filter contain small particles or pigments.

(4) The liquid crystal display device according to the present invention has the configuration described in (1), for example, wherein a red color filter contains small particles or pigments.

(5) The liquid crystal display device according to the present invention has the configuration described in (1), for example, wherein the first and second electrodes include a sheet electrode formed on the first substrate and a set of electrodes formed over the electrode with an insulator formed over the electrode being provided between the electrode and the set of electrodes.

(6) The liquid crystal display device according to the present invention has the configuration described in (1), for example, and includes a gate electrode, a thin film transistor which is turned on by a scanning signal from the gate electrode, a source electrode which supplies a video signal to one of the first and second electrodes through the turned-on thin film transistor, and a common electrode which supplies a reference signal which acts as a reference for the video signal to the other electrode of the first and second electrodes.

(7) A liquid crystal display device according to the present invention includes, for example:

a first substrate and a second substrate;

a liquid crystal layer disposed between the first and second substrates;

a first electrode provided on the first substrate and a second electrode which applies an electric field to the liquid crystal layer by an electric potential difference produced between the first electrode and the second electrode; and color filters provided on the first substrate or the second substrate;

the liquid crystal layer has a property of changing from an optically isotropic state to an optically anisotropic state in response to application of a voltage; and

the color filters include at least a blue color filter made of a dye material.

(8) The liquid crystal display device according to the present invention has the configuration described in (7), for example, wherein a green color filter is made of a dye material and a red color filter is made of a material in which pigments are distributed.

(9) The liquid crystal display device according to the present invention has the configuration described in (7), for example, wherein a green color filter and a red color filter are made of a material in which pigments are distributed.

(10) The liquid crystal display device according to the present invention has the configuration described in (7), for example, wherein the first and second electrodes include a sheet electrode formed on the first substrate and a set of electrodes formed over the electrode with an insulator formed over the electrode being provided between the electrode and the set of electrodes.

(11) The liquid crystal display device according to the present invention has the configuration described in (7), for example, and includes: a gate electrode, a thin film transistor which is turned on by a scanning signal from the gate electrode, a source electrode which supplies a video signal to one of the first and second electrodes through the turned-on thin film transistor, and a common electrode which supplies a reference signal which acts as a reference for the video signal to the other electrode of the first and second electrodes.

(12) A liquid crystal display device according to the present invention includes, for example:

a first substrate and a second substrate;

a liquid crystal layer disposed between the first and second substrates;

a first electrode provided on the first substrate and a second electrode which applies an electric field to the liquid crystal layer by an electric potential difference produced between the first electrode and the second electrode; and

color filters provided on the second substrate;

wherein the liquid crystal layer has a property of changing from an optically isotropic state to an optically anisotropic state in response to application of a voltage; and

the color filters include at least a blue color filter made of a dye material.

(13) The liquid crystal display device according to the present invention has the configuration described in (12), wherein a green color filter and a red color filter are made of a dye material.

(14) The liquid crystal display device according to the present invention has the configuration described in (12), for example, wherein a green color filter is made of a dye material and a red color filter is made of a material in which pigments are distributed.

(15) The liquid crystal display device according to the present invention has the configuration described in (12), for example, wherein a green color filter and a red color filter are made of a material in which pigments are distributed.

(16) The liquid crystal display device according to the present invention has the configuration described in (12), for example, wherein the first and second electrodes include a sheet electrode formed on the first substrate and a set of electrodes formed over the electrode with an insulator formed over the electrode being provided between the electrode and the set of electrodes.

(17) The liquid crystal display device according to the present invention has the configuration described in (12), for example, and includes a gate electrode, a thin film transistor which is turned on by a scanning signal from the gate electrode, a source electrode which supplies a video signal to one of the first and second electrodes through the turned-on thin film transistor, and a common electrode which supplies a reference signal which acts as a reference for the video signal to the other electrode of the first and second electrodes.

The present invention is not limited to the configurations described above. Various modifications can be made without departing from the technical idea of the present invention.

(18) The liquid crystal display device according to the present invention has the configuration described in (1), for example, wherein the polarizing plate is formed by an E-type polarizer.

(19) The liquid crystal display device according to the present invention has the configuration described in (18), for example, wherein the polarizing plate is formed on a surface of each of the first substrate and the second substrate opposite the liquid crystal layer.

(20) The liquid crystal display device according to the present invention has the configuration descried in (19), for example, wherein the polarizing plate is protected by a protective film or a protective plate.

(21) The liquid crystal display device according to the present invention has the configuration described in (19), for example, wherein the polarizing plate is formed by applying an E-type polarizer onto a film surface.

(22) The liquid crystal display device according to the present invention has the configuration described in (18), for example, wherein the polarizing plate is formed on a surface of each of the first substrate and the second substrate that faces the liquid crystal.

(23) The liquid crystal display device according to the present invention has the configuration described in (1), for example, and includes a liquid crystal display panel and a backlight disposed at the rear of the liquid crystal display panel with an optical sheet being provided between the liquid crystal panel and the backlight, wherein

the polarizing plate is formed by an E-type polarizer; and

the optical sheet is formed so that an emission angle of outgoing light traveling to the liquid crystal display panel is increased with respect to incident light from the backlight.

(24) The liquid crystal display device according to the present invention has the configuration described in (23), for example, wherein the polarizing plate is formed on a surface of each of the first substrate and the second substrate opposite the liquid crystal layer.

(25) The liquid crystal display device according to the present invention has the configuration described in (24), for example, wherein the polarizing plate is formed on a surface of each of the first substrate and the second substrate that faces the liquid crystal.

(26) The liquid crystal display device according to the present invention has the configuration described in (24), for example, wherein the first and second electrodes include a sheet electrode formed on the first substrate and a set of electrodes formed over the electrode with an insulator formed over the electrode being provided between the electrode and the set of electrodes.

(27) The liquid crystal display device according to the present invention has the configuration described in (24), for example, wherein the optical sheet includes a cluster of convex lenses formed on a surface facing the liquid crystal display panel, and windows capable of transmitting light are formed on the backside at bottoms of the convex lenses.

The present invention is not limited to the configurations described above. Various modifications can be made without departing from the technical idea of the present invention.

A liquid crystal display device configured as described above is capable of reducing the difference in hue between black and white states. That is, the liquid crystal display device is capable of achieving a black state closer to an achromatic color, improving the color purities of red and green at low gray levels, and further improving the viewing angle characteristics with a simple and inexpensive configuration.

### BRIEF DESCRIPTION OF THE SEVERAL VIEWS OF THE DRAWING

FIG. 1 is a plan view of one embodiment of a color filter of a liquid crystal display device according to the present invention, viewed from a liquid crystal layer;

FIG. 2 is a schematic perspective view showing a general view of one embodiment of the liquid crystal display device according to the present invention;

FIG. 3 is a diagram illustrating one embodiment of a polarizing plate of the liquid crystal display device according to the present invention;

FIG. 4 is an equivalent circuit diagram showing one embodiment of pixels of the liquid crystal display device according to the present invention;

FIG. 5 is a diagram showing a configuration of a pixel of the liquid crystal display according to one embodiment of the present invention;

FIG. 6 is a cross-sectional view taken along line VI-VI of FIG. 5A;

FIG. 7 shows graphs of spectral radiance in a black state versus spectral radiance in a white state provided when color filters are made of dye materials;

FIG. 8 is a graph of spectral transmittance in a black state when color filters in different colors are made of dye materials and small particles are added to red and green color filters;

FIG. 9 is a chromaticity diagram showing an advantageous effect of the liquid crystal display device according to the present invention;

FIG. 10 shows graphs of spectral radiances in black and white states of a conventional liquid crystal display device;

FIG. 11 is a graph showing spectral radiance caused by scattering in color filters in a black state of the conventional liquid crystal display device;

FIG. 12 is a diagram showing a configuration of one embodiment of a polarizing plate used in the liquid crystal display device according to the present invention;

FIG. 13 is a diagram showing a structure of an O-type polarizer;

FIG. 14 is a diagram showing a structure of one embodiment of an optical sheet used in the liquid crystal display device according to the present invention; and

FIG. 15 is a cross-sectional view of a liquid crystal display device according to another embodiment of the present invention.

### DESCRIPTION OF SYMBOLS

CF Color filter
PIX Pixel
CPIX Pixel in color display
PNL Liquid crystal display panel
OST Optical sheet
DBD Diffuser
BL Backlight
CDR Cold cathode fluorescent lamp
PL1, PL2 Polarizing plate
SUB1, SUB2 Transparent substrate
V Scanning signal driver circuit
He Imaging signal driver circuit
GL Gate signal line
CL Common signal line
DL Drain signal line
TFT Thin film transistor
PX Pixel electrode
CT Counter electrode
GL Insulator
PSV1, PSV2 Protective film
SL Sealing paste
AR Liquid crystal display area
RFB Reflector
PLA1, PL2 Transmit axis
AS Semiconductor layer
DT Drain electrode
ST Source electrode
GI Insulator
PAS1, PAS2 Protective film
PIX Pixel
BM Black matrix
OC Planarizing overcoat
LQ Liquid crystal
PG Coloring matter
IO Iodine
LES Convex lens
WD Window
SFL1, SFL2 Surface film

### DETAILED DESCRIPTION OF THE INVENTION

Embodiments of a liquid crystal display device according to the present invention will be described below with reference to the accompanying drawings.

Overview

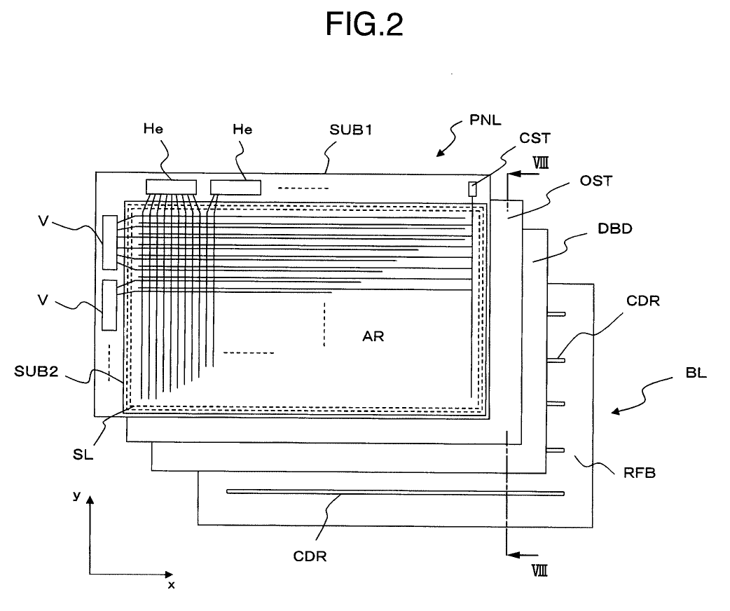

FIG. 2 is an overall perspective view schematically showing a liquid crystal display device according to the present invention. The liquid crystal display device in FIG. 2 includes a liquid crystal display panel PNL, an optical sheet OST, a diffuser DBD, and a backlight BL disposed in this order viewed from a viewer of the display device.

The liquid crystal display panel PNL has an enclosure which is a pair of transparent substrates SUB1 and SUB2 containing a liquid crystal between them. Transparent substrate SUB2 is formed somewhat smaller in area than transparent substrate SUB1 so as to expose the left-side edge portion and the upper edge portion, for example, of transparent substrate SUB1, and is faced with transparent substrate SUB1. Provided side by side on the left-side edge portion of transparent substrate SUB1 are multiple scanning driver circuits V formed by face-down semiconductor chips; provided side by side on the upper edge portion are multiple video signal driver circuits He formed by face-down semiconductor chips.

Transparent substrate SUB2 is fixed on transparent substrate SUB1 with sealing paste SL formed around the perimeter of transparent substrate SUB2. The sealing paste SL also functions as a sealant that seals the liquid crystal contained between transparent substrates SUB1 and SUB2. The region in which the liquid crystal is sealed, that is, the region surrounded by the sealing paste SL, is structured as a liquid crystal display area AR.

Gate signal lines GL and common signal lines CL are formed in the liquid crystal display area AR on the surface of transparent substrate SUB1 that faces the liquid crystal. The gate signal lines GL and common signal lines CL are extended in the x direction in FIG. 2 and provided in parallel with each other in the y direction. For example, the gate signal lines GL and common signal lines CL are arranged in such a manner that a gate signal line GL is provided at the top in FIG. 2, a common signal line CL is provided at a relatively great distance from the gate signal line GL, a gate signal line GL is provided at a small distance from the common signal line CL, and a common signal CL is provided at the relatively great distance from the gate signal line GL, and so on.

On the surface in the liquid crystal display area AR that faces the liquid crystal, drain signal lines DL electrically insulated from the gate signal lines GL and common signal lines CL are extended in the y direction in parallel with each other in the x direction in FIG. 2.

A pixel is formed in each region surrounded by a pair of adjacent gate signal lines GL and a pair of adjacent drain signal lines DL. Such pixels are arranged in a matrix to form the liquid crystal display area AR. The configuration of each pixel will be detailed later.

Each of the gate signal lines GL extends beyond the sealing paste SL on the left-hand side of FIG. 2 and is connected to an associated electrode (not shown) of the scanning signal driver circuit V. The scanning signal driver circuits V provide a gate signal consisting of rectangular pulses, for example, to the gate signal lines GL from the top to bottom of FIG. 2 in sequence so that a row of pixels formed along a gate signal line GL to which the gate signal is provided can be selected.

Each of the drain signal lines DL extends beyond the sealing paste SL at the top of FIG. 2 and is connected to an associated electrode (not shown) of the video signal driver circuit He. The video signal drive circuit He provides a video signal to each drain signal line DL in synchronization with output of the gate signal from the scanning signal driver circuit V. Thus, a video signal is applied to each pixel of a selected row of pixels.

The common signal lines CL are common-connected with each other at the right-hand end of FIG. 2, for example, are then extended beyond the sealing paste SL and connected to a common signal supply terminal CST. The common signal supply terminal CST is supplied with a common signal, which is a voltage acting as a reference for the voltage of the video signal. The common signal is provided to each pixel through the common signal line CL.

An electric field according to the difference between the voltage of the video signal and the voltage of the common signal is applied to the liquid crystal of each pixel to which the common signal and video signal are supplied. Molecules of the liquid crystal behave in accordance with the intensity of the electric field to change the light transmittance.

The backlight BL is provided at the rear of the liquid crystal display panel PNL (the side opposite a viewer) with the optical sheet OST and the diffuser DBD being provided between the panel PNL and the backlight BL. Light from the backlight BL travels through the diffuser DBD and the optical sheet OST, and passes through the pixels of the liquid crystal display panel PNL to the eyes of a viewer.

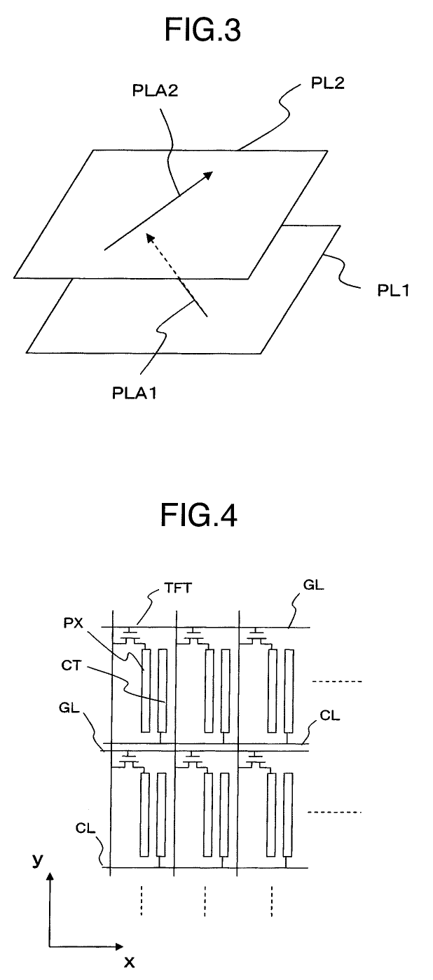

Although not shown in FIG. 2, a polarizing plate is formed on the surface of each of transparent substrates SUB1 and SUB2 of the liquid crystal display panel PNL on the side opposite the liquid crystal. The polarizing plates are provided in order to make changes of behavior of the liquid crystal optically visible. Therefore the polarizing plates are formed in such a manner that each of the polarizing plates covers at least the liquid crystal display area AR. FIG. 3 shows polarizing plate PL1 formed on the surface of transparent substrate SUB1 on the side opposite the liquid crystal and polarizing plate PL2 formed on the surface of transparent substrate SUB2 on the side opposite the liquid crystal. The transmit axis (absorption axis) PLA1 of polarizing plate PL1 and the transmit axis (absorption axis) PLA2 of polarizing plate PL2 cross each other in a crossed Nicol arrangement.

The backlight BL, which may be a so-called direct backlight, consists of multiple cold cathode fluorescent lamps CDR facing the liquid crystal display area AR of the liquid crystal display panel PNL, for example. The cold cathode fluorescent lamps CDR are disposed on the inner surface of the exterior frame of the backlight BL on which a reflector RFB is provided. The cold cathode fluorescent lamps are disposed in parallel with each other in the y direction and the direction of the length of the cold cathode fluorescent lamps CDR is aligned with the x direction in FIG. 2.

The direct backlight BL is suitable for a large liquid crystal display panel PNL. The backlight BL may consist of an optical waveguide of an approximately the same size and shape as the liquid crystal display panel PNL and cold cathode fluorescent lamps, for example, disposed on the sides of the optical waveguide. The light source may be a direct backlight source using light emitting diodes (LEDs) or may be a backlight having LEDs provided on the sides. Alternatively, the light source may be an organic electroluminescence (OLED).

Equivalent Circuits of Pixels

FIG. 4 shows one embodiment of equivalent circuits of pixels in the liquid crystal display area AR of the liquid crystal display device according to the present invention and shows circuits formed on the surface of transparent substrate SUB1 on the side facing the liquid crystal. FIG. 4 shows adjacent 2×3 pixels taken from the pixels shown in FIG. 2.

As descried above, each pixel is defined by a pair of adjacent drain signal lines DL and a pair of adjacent gate signal lines GL.

A thin film transistor TFT having an MIS structure is formed in one corner of the pixel and the gate electrode of the thin film transistor is connected to the nearby gate signal line GL and the drain electrode is connected to the nearby drain signal line DL.

A pixel electrode PX and a counter electrode CT, which are a pair of electrodes, are formed in each pixel region. The pixel electrode PX is connected to the source electrode of the thin film transistor TFT and the counter electrode CT is connected to the common signal line CL.

In this circuit configuration, a reference voltage (voltage acting as a reference for the video signal) is applied to the counter electrode CT of each pixel through the common signal line CL and a gate voltage is applied to the gate signal lines GL in sequence starting from the top, for example, of FIG. 4 to select a row of pixels. At the timing of the selection, a video signal is provided to each drain signal line DL to apply a voltage of the video signal to the pixel electrode PX of each pixel of the row through the thin film transistor TFT turned on by the gate voltage. An “in-plane electric field” is generated between the pixel electrode PX and the counter electrode CT that has an intensity corresponding to the voltage of the video signal. The liquid crystal behaves in accordance with the intensity of the in-plane electric field.

The circuit described above has the same geometric arrangement as that of the pixel configuration, which will be described later, in terms of the gate signal line GL, drain signal line DL, and thin film transistor TFT. For example, the counter electrode CT is formed as a sheet that covers most of the region of each pixel; the pixel electrode PX consists of multiple strip electrodes formed over the counter electrode CT with an insulator being contained between them.

Thus, in addition to the liquid crystal, a capacitor having the insulator as its dielectric film is formed between the pixel electrode PX and the counter electrode CT. When a video signal is applied to the pixel electrode PX, the applied video signal is stored in the capacitor for a relatively long period of time.

Configuration of Pixels

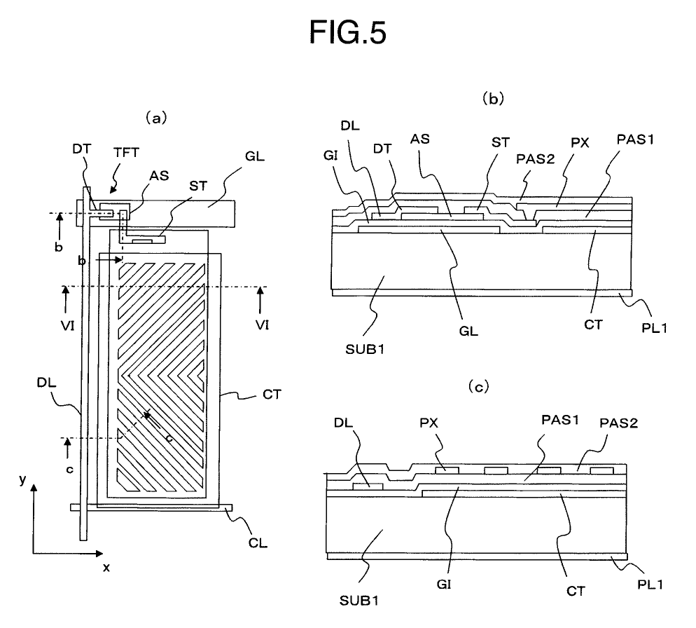

FIG. 5 shows a configuration of a pixel formed on the surface of the transparent substrate SUB1 on the side facing the liquid crystal.

FIG. 5A in FIG. 5 is a plan view of the pixel, FIG. 5B is a cross-sectional view taken along line b-b of FIG. 5A, and FIG. 5C is a cross-sectional view taken along line c-c of FIG. 5A.

Formed on the surface (top surface) of the transparent substrate SUB1 on the side facing the liquid crystal are a gate signal line GL and a common signal line CL a relatively large distance apart from each other and in parallel with each other.

A counter electrode CT made of a transparent conductive material such as ITO (Indium-Tin-Oxide) is formed in the region between the gate signal line GL and the common signal line CL. An edge portion of the counter electrode CT at the common signal line CL is superimposed on the common signal line CL. The superimposition electrically connects the counter electrode CT to the common signal line CL.

An insulator GI is formed on the top surface of the transparent substrate SUB1 so as to cover the gate signal line GL, the common signal line CL, and the counter electrode CT. The insulator GI acts as a gate insulator of a thin film transistor TFT, which will be described later, in a region where the thin film transistor is formed and is formed to a thickness accordingly.

A semiconductor layer AS made of amorphous silicon, for example, is formed on the top surface of the insulator GI in a region overlapping a portion of the gate signal line GL. The semiconductor layer AS functions as a semiconductor layer of the thin film transistor TFT.

A drain signal line DL is formed that extends along the y direction in FIG. 5. An extending portion of the drain signal line DL is staked on the semiconductor layer AS. The extending portion functions as the drain electrode DT of the thin film transistor TFT.

A source electrode ST formed at the same time the drain signal line DL and the drain electrode DT are formed faces the drain electrode DT on the semiconductor layer AS. The source electrode ST has an extending portion that is somewhat extended from the semiconductor layer AS toward the pixel region. The extending portion forms a pad that will be connected to a portion of a pixel electrode PX, which will be described later.

When the semiconductor layer AS is formed on the insulator GI, the surface of the semiconductor layer AS is highly doped with an impurity. After the drain electrode DT and the source electrode ST are formed by patterning, the drain electrode DT and the source electrode ST are used as a mask to etch the highly doped impurity layer formed in a region except the region where the drain electrode DT and the source electrode ST are formed. The highly doped impurity layer is thus left in the region between the semiconductor layer AS and the drain electrode DT and the region between the semiconductor layer AS and the source electrode ST so that the impurity layer is provided as an ohmic contact layer.

In this way, the thin film transistor TFT is formed as an inversely staggered MIS transistor having the gate signal line GL as its gate electrode.

The MIS transistor is driven by applying a bias voltage so that the drain electrode DT and the source electrode ST are replaced with each other. In the description of this embodiment, the end of the MIS transistor that is connected to the drain signal line DL is referred to as the drain electrode DT and the end connected to the pixel electrode PX is referred to as the source electrode ST for convenience.

A first protective film PAS1 is formed on the top surface of the transparent substrate SUB 1 so as to cover the thin film transistor TFT. The first protective film PAS1 is provided in order to prevent the thin film transistor TFT from directly contacting with the liquid crystal. The first protective film PAS1 is provided between the counter electrode CT and the pixel electrode PX, which will be described later so as to also function as a dielectric film of the capacitor together with the insulator GI.

The pixel electrode PX is formed on the top surface of the first protective film PAS1. The pixel electrode PX is made of a transparent conductive material such as ITO (Indium-Tin-Oxide) and is formed so as to cover a wide area of the counter electrode CT.

In the pixel electrode PX, many slits are formed in parallel with each other along the direction that crosses the longer side of the pixel electrode PX so that the pixel electrode PX has many strip electrodes connected with each other at both ends.

A second protective film PAS2 is formed on the surface of the transparent substrate SUB1 so as to cover the pixel electrode PX. The second protective film PAS2 is provided in order to prevent the pixel electrode PX from electrically connecting to the liquid crystal, for example. The liquid crystal display device in this embodiment uses an isotopic liquid crystal material as will be described later.

Accordingly, an alignment film can be omitted. In that case, an insulator such as the second protective film PAS2 must be provided.

The electrodes constituting the pixel electrode PX are formed as follows. The pixel area is divided into two, upper and lower regions, as shown in FIG. 5A, for example. Electrodes are formed in one of the regions so that the electrodes extend at an angle of +45 degrees with respect to the direction in which the gate signal line GL runs. Electrodes in the other region are formed so that the electrodes extend at an angle of −45 degrees with respect to the direction in which the gate signal line GL runs. The use of the so-called multi-domain method solves the problem that coloring of the display, which would occur depending on viewing angles if the slits (electrodes of the pixel electrode PX) provided in the pixel electrode PX in one pixel are aligned in a single direction. The electrodes do not necessarily need to be arranged in this way.

While the semiconductor layer of the thin film transistor TFT in the embodiment described above is made of amorphous silicon, the semiconductor layer may be made of polysilicon.

Configuration of Transparent Substrate SUB2

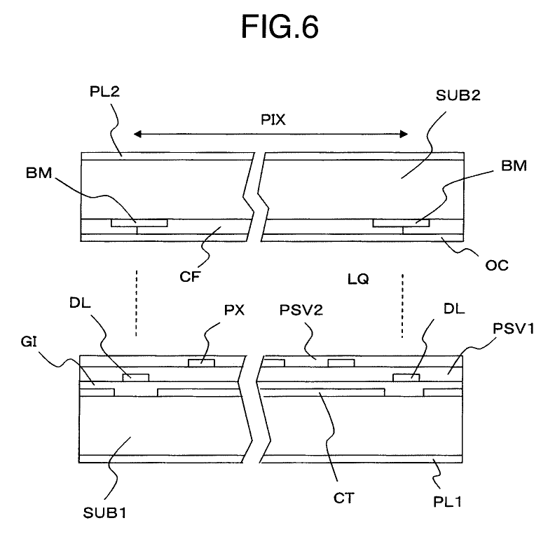

FIG. 6 is a cross-sectional view taken along line VI-VI of FIG. 5A, also showing a transparent substrate SUB2 which is opposed to the transparent substrate SUB1 with a liquid crystal QL containing between them.

A black matrix BM is formed on the surface of the transparent substrate SUB2 on the side facing the liquid crystal. The black matrix BM is provided in order to separate each pixel PIX from adjacent pixels PIX and is formed so as to cover the gate signal lines GL, the common signal lines CL, and the drain signal lines DL on the transparent substrate SUB1. Thus, the black matrix BM has a pattern in which an opening is formed in the middle portion of each pixel PIX surrounded by these regions. The black matrix BM also covers thin film transistors TFT, not shown, to prevent characteristics of the semiconductor layer from being changed by illumination with light.

Color filters CF are formed in a portion where openings are formed in the black matrix BM. The regions surrounding the color filters are covered by the black matrix BM. The color filters CF are formed as follows. A red (R) color filter CF, a green (G) color filter CF, and a blue (B) color filter CF are formed on adjacent three pixels and the three pixels form one full-color pixel. The color filters CF will be described later in further detail.

A planarizing overcoat OC made of a resin, for example, is formed so as to cover the color filters CF. Like transparent substrate SUB1, transparent substrate SUB2 does not have an alignment film.

A polarizing plate PL2 is formed on the surface of the transparent substrate SUB2 opposite side of the liquid crystal LQ.

Each pixel PIX thus formed is in a so-called normally black mode in which an electric field is not generated between the pixel electrode PX and the counter electrode CT to provide a black state.

Liquid Crystal Materials

An isotropic liquid crystal is used as the liquid crystal LQ material that is optical isotropic in the absence of a voltage, for example.

By using an isotropic liquid crystal, the dependency of the transmittance of the liquid crystal LQ on viewing angles can be avoided. In addition, an isotropic liquid crystal can prevent light scattering caused by thermal fluctuations of the liquid crystal LQ in the black state when a voltage is not applied, thereby preventing a decrease in contrast ratio due to light leakage.

The liquid crystal LQ may be obtained as follows for example. Non liquid crystal monomer represented by Formulae (1) to (3), a liquid crystal monomer represented by Formula (4), and an epoxy-type thermal crosslinking material represented by Formula (5) are used to obtain an isotropic liquid crystal material represented by Formulae (6) to (10) by thermal crosslinking.

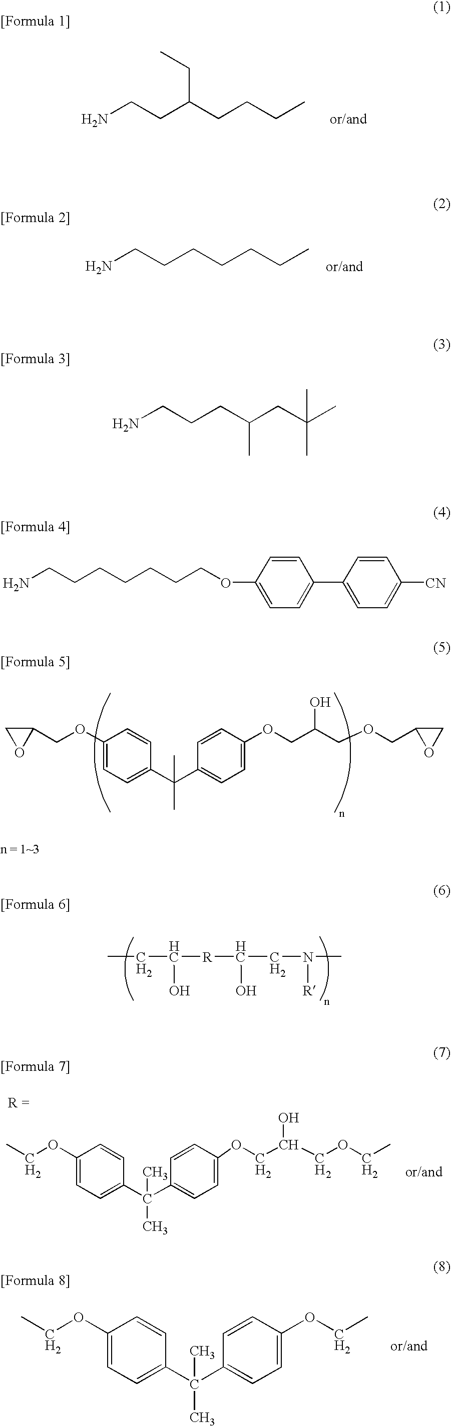

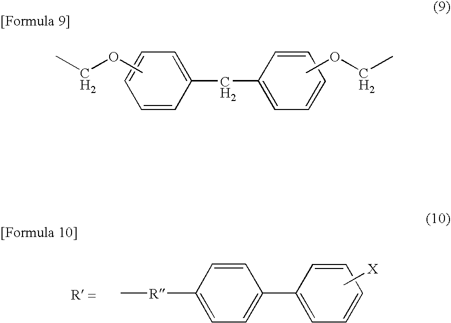

Here, R″ is an alkyl linear chain with a carbon number of 2 to 10 or a methoxy group that has an alkyl linear chain with a carbon number of 2 to 10. X is one of hydrogen, fluorine, methyl group, ethyl group, cyano group, methoxy group, acetyl group, or carboxylic acid group, or a compound of any of these. R′ is CmH (2m+1):m=5 to 10.

By using a liquid crystal LQ material having a composition given above, an isotropic liquid crystal can be generated without illumination with light, for example. Such a liquid crystal LQ has the effect of resolving the problem that the color filters CF block ultraviolet UV that would otherwise have to be applied to the liquid crystal LQ to provide photocrosslinking after it is sealed in a liquid crystal cell.

The liquid crystal LQ materials given above are examples that can be used for a liquid crystal display device of the present invention but are not limitative. In essence, any a liquid crystal may be used that have a property that generates optical anisotropy when a voltage is applied to the liquid crystal in the optically isotropic state. Therefore, any other variations of liquid crystals modified without impairing the property may be used.

Color Filter CF

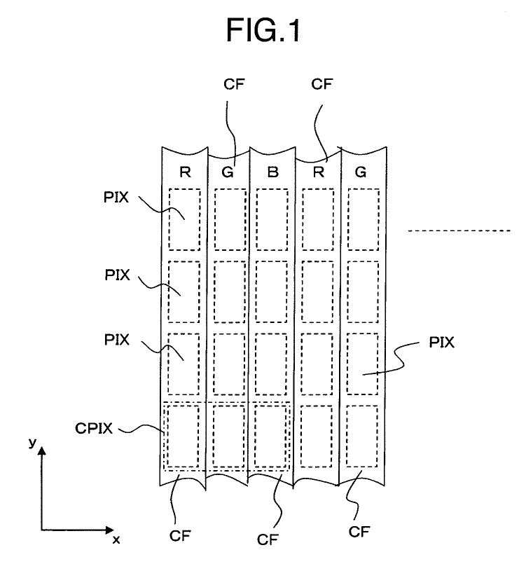

FIG. 1 is a plan view of the color filters CF formed on the transparent substrate SUB2, viewed from the liquid crystal.

The pixels PIX in FIG. 1 are arranged in a matrix in the liquid crystal display area AR on the surface of transparent substrate SUB 2. The matrix has rows in the x direction in the figure and columns in the y direction.

Color filters CF in the same color are formed in a pattern of strips covering the regions of pixels PIX arranged in the y direction in FIG. 1. The color filters CF in a strip patterns are arranged in the x direction in FIG. 1 like, for example, red (R), green (G), blue (B), red (R), green (G), . . . , and so on.

Three adjacent pixels PIX (for example pixels PIX enclosed by the alternate long and short dash box in FIG. 1) that are arranged in the x direction and have color filters CF in different colors function as a full-color display pixel CPIX.

The arrangement of the pixels having different color filters in the color display pixel CPIX is not limited to the one described above (called stripe arrangement). It will be understood that any other arrangement (for example mosaic arrangement or delta arrangement) may be used provided that three pixels of different colors are arranged adjacent to each other.

The color filters CF in this embodiment are made of a synthetic resin containing dyes, for example. That is, a red color filter CF contains a red dye, a green color filter CF contains a green dye, and a blue color filter CF contains a blue dye. The materials of these color filters CF can be considered as dye materials.

These color filters CF are formed as follows. A photosensitive dye material (photoresist) is applied onto the right surface of a transparent substrate SUB2 and then the surface is patterned using photolithography technology. This process is repeated for each of read (R), green (G), and blue (B) color dye materials.

By using the color filters CF thus formed, light leakage through the color filters CF can be avoided without decreasing the contrast ratio in the black state in the absence of a voltage (normally black). This has the effect of reducing bluish coloring in the black state. Thus, the black state close to an achromatic color state can be achieved and the color purities of read and green at low gray levels can be improved.

The color filters of conventional liquid crystal display devices are made of synthetic resins containing pigments, for example. It has been found that small particles of the pigments in the color filters produce so-called Rayleigh scattering in light from the backlight BL in the black state in the absence of a voltage (normally black), which then causes light leakage. In the present embodiment, therefore, dye materials are used for the color filters to significantly minimize occurrence of the Rayleigh scattering.

The particles of the pigments are several tens to several hundred nanometers in diameter. Such pigment particles are distributed in the synthetic resins of the conventional color filters CF. In contrast, the dye materials mentioned above consist of molecules as small as several nanometers in diameter. The color filters CF in the present embodiment are made of dye materials containing such dyes. The Reyleigh scattering is caused by particles of sizes about 1/10 of the wavelength of light at the smallest. Therefore the pigments cause the Reyleigh scattering, which then causes depolarization to reduce the contrast ratio. In contrast, coloring matters contained in dyes are not particles and do not cause scattering. Therefore scattering does not occur and the contrast ratio is not reduced.

It should be noted that observations have shown that particles, for example particles of silica, that have diameters smaller than those of pigments but greater than those of dyes distributed in color filters reduce the contrast ratio.

In the present embodiment, color filters CF having the configuration described above are formed on transparent substrate SUB2 as shown in FIG. 6. Thus, the color filters CF can be reliably formed and therefore the advantageous effect of using the color filters CF described above can be fully provided.

That is, in an in-plane switching mode liquid crystal display device, a pair of electrodes that generate an electric field and signal lines connected to the electrodes are formed on one substrate (transparent substrate SUB1 in the present embodiment) and no such electrodes and signal lines are formed on the other substrate (transparent substrate SUB2 in the present embodiment).

This means that a process in which high-temperature processing such as spattering is not involved. This fact is highly advantageous in forming color filters CF in which dyes are distributed. The reason is that color filters CF in which dyes are distributed are more easily affected by high-temperature than color filters CF in which pigments are distributed. If electrodes and the like are formed by high-temperature processing such as spattering after the color filters CF are formed, the high-temperature processing can disperse dyes from the color filters CF. Other embodiments of color filters CF

In the embodiment described above, red color filters CF are made of a red dye material, green color filters CF are made of a green dye material, and blue color filters CF are made of a blue dye material.

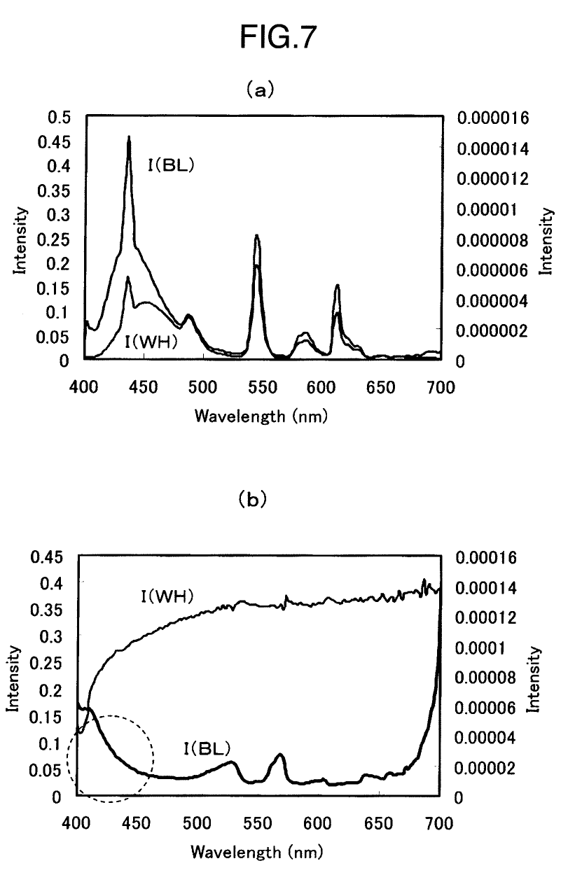

In this case, investigations on spectral radiances in the black state and white state have provided the results shown in the graph of FIG. 7A. The horizontal axis of the graph represents wavelength, vertical axis represents the intensity of spectral radiance, curve I (BL) represents a spectral radiance in the black state, and curve I (WH) represents a spectral radiance in the white state.

As can be seen from the graph, there is a little difference in hue between the black and white states. Studies have shown that the difference has resulted from the difference between the so-called cross spectrum characteristic (curve I (BL)) in the polarizing plates PL1 and PL2 in the black state and the so-called parallel spectrum characteristic (curve I (WH)) in the polarizing plates PL1 and PL2 in the white state as shown in FIG. 7B.

Considering that a blue color can easily pass through a filter as can be seen in the portion of the cross spectrum characteristic (curve I (BL)) enclosed in the dashed circle in FIG. 7B, the difference in hue mentioned above can be minimized by adding a small number of particles (for example silica particles) to the red (R) color filters CF and the green (G) color filters CF to the color-filters except the blue (B) color filters CF, namely to. The purpose of adding the small particles is to actively generate Rayleigh scattering in the red (R) and green (G) color filters CF. In this case, the contrast ratio can be a value within the range from 2000 to 3000, for example.

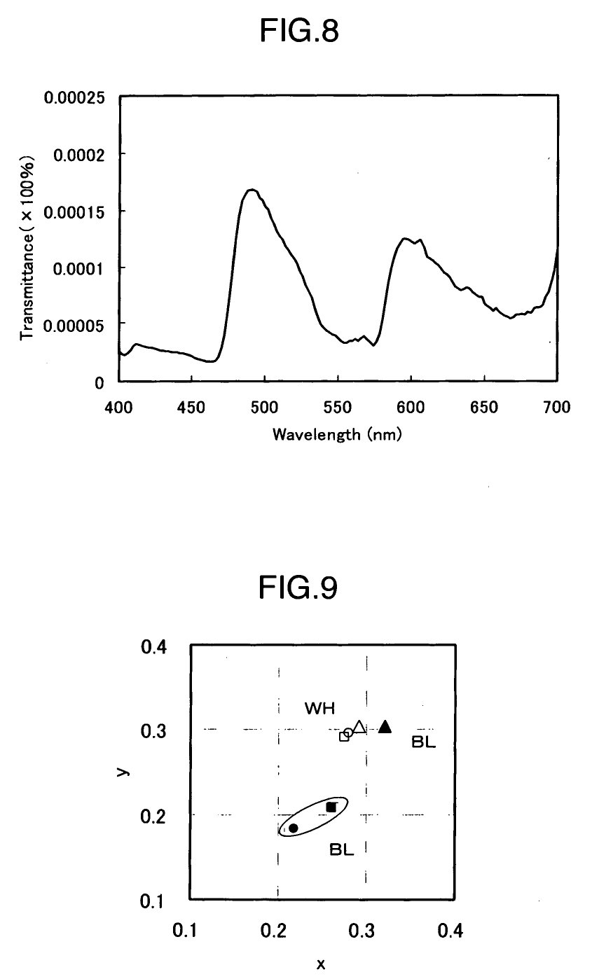

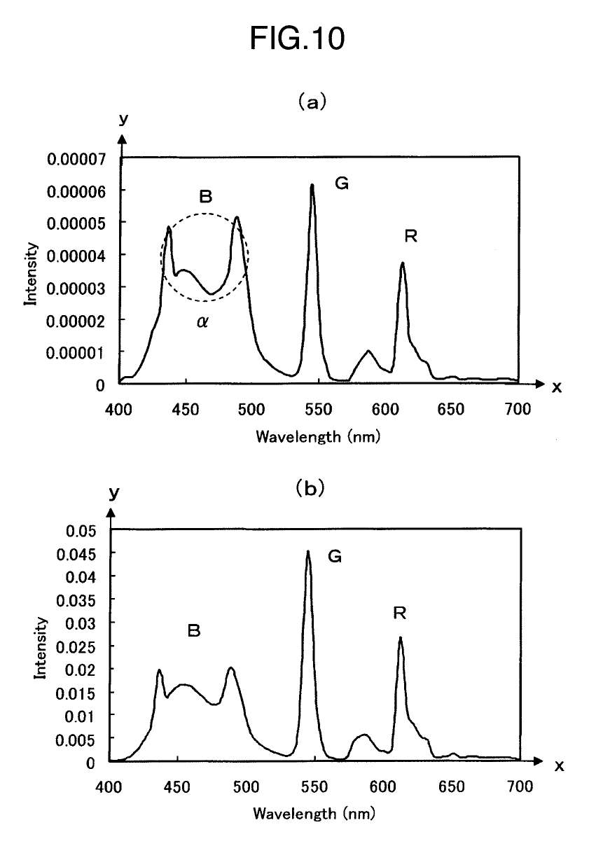

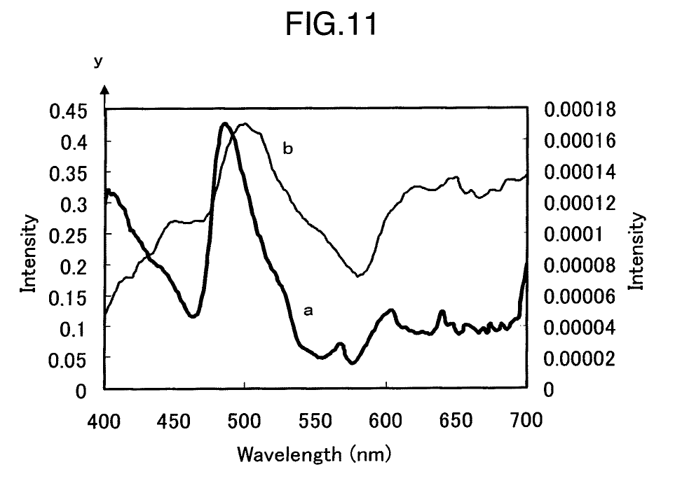

FIG. 8 is a graph of a spectral transmittance in the black state in a liquid crystal display device in which a small number of particles are added to the red (R) and green (G) color filters CF. The horizontal axis of the graph represents wavelength and the vertical axis represents transmittance. It can be seen from the graph that a high contrast ratio can be achieved and therefore the color purities of red and green at low gray levels do not decrease and high-quality display can be provided. FIG. 9 is an x-y chromaticity diagram showing black and white chromaticities of the liquid crystal display device obtained in this case. In FIG. 9, the black circle, rectangle, and triangle represent blue (B), red (R), and green (G), respectively, in the black state and the white circle, rectangle and triangle represent blue (B), red (R), and green (G) in the white state. As can be seen from FIG. 9, the addition of the particles has the effect of causing the chromaticity of the black color to approach the chromaticity of the white color.

The red (R), blue (B), and green (G) color filters CF are made of dye materials and small particles are added to the red color filters CF in the embodiment described above. However, a pigment may be included in the red color filters CF without adding small particles. This can prevent an increase of the transmittance of short wavelength which would be caused by Reyleigh scattering with small particles.

That is, if the intensity of scattering is controlled by adding small particles, the transmittance of light of short wavelengths, for example less than 450 nm, will be increased and light leakage can occur.

The intensity of scattering in this case is proportional to the 6-th power of the diameter of a particle and to ¼ power of the wavelength of light.

Using a pigment in the red color filters CF can solve the problem described above because the pigment consists of small particles of a coloring matter, which can absorb light of short wavelengths.

Small particles may be added to the green color filters CF in the embodiment described above because the addition of small particles to the green color filters does not contribute to leakage of light of wavelengths between 400 and 450 nm, for example.

This configuration has the effect of displaying a red color with a better color purity at low gray levels.

The liquid crystal display devices in the embodiments described above are so-called transmissive liquid crystal display devices. Of course, the embodiments can also be applied to semi-transparent or reflective liquid crystal display devices as well. In those cases, the pixel electrodes PX or counter electrodes CT may be made of conductive materials that are opaque according to the types of the display devices. For example, in the case of a semi-transparent liquid crystal display device, the pixel electrodes PX of the liquid crystal display device may be made of a material having a good light reflection efficiency such as aluminum; in the case of a reflective liquid crystal display device, the counter electrode CT may be made of a material having a good light reflection efficiency such as aluminum.

The embodiments described above may be used independently or in combination. That is, the effects of the embodiments can be produced independently or synergistically.

Polarizing Plates

Polarizing plates PL1 and PL2 described above are so-called E-type polarizers. Such polarizing plates are called E (extraordinary) type polarizing plates because they transmit extraordinary light and absorb ordinary light in contrast with polarizing plates generally called O (ordinary) type polarizing plates (which transmit ordinary light and absorbs extraordinary light).

Polarizing plates PL1 and PL2 consisting of E-type polarizers themselves have good viewing angle characteristics and can provide very wide viewing angles compared with O-type polarizers.

It has been shown that using E-type polarizers as polarizing plates PL1 and PL2 in a liquid crystal display device that uses a optically isotropic liquid crystal as described above prevents the problem of light leakage (oblique light leakage) which would otherwise be caused by behavior of the liquid crystal in the normal black state, and therefore a high contrast ratio can be achieved.

It has been found that, if E-type polarizers are used as polarizing plates in a liquid crystal display device that uses a liquid crystal that is not optically isotropic, a large amount of light leakage occurs and accordingly the contrast ratio is significantly decreased. Therefore polarizing plates formed by E-type polarizers have not been used in conventional liquid crystal display devices.

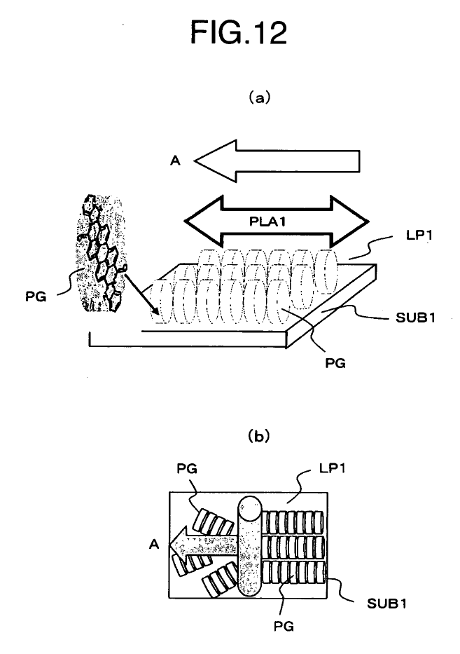

FIG. 12A is an enlarged view of a polarizing plate LP1 which is an E-type polarizer formed on the surface of a transparent substrate SUB1, for example, on the side opposite the liquid crystal LQ.

The polarizing plate LP1 in FIG. 12A forms a chromonic liquid crystal phase, for example, and includes a coloring matter PG having a disc-like framework. The coloring matter PG having a disc-like framework has a structure in which aromatic rings are linked and may be perylene or naphthalene, for example.

The direction of the transmit axis PLA1 of the polarizing plate LP1 implemented by an E-type polarizer having the configuration described above is as shown in the figure and is agreed with the direction A in which a material used in forming the polarizing plate LP1 is applied in the formation of the polarizing plate LP1.

That is, as shown in FIG. 12B, a dichroic lyotropic liquid crystal (soluble in water) is fallen in drops onto the transparent substrate SUB1 and a roller R is moved in the application direction A. Shearing stress generated by this application causes the coloring matter PG to be self-aligned and the transmit axis PLA1 of the polarizing plate LP1 thus formed becomes aligned with the application direction A.

The E-type polarizing plate PL1 is considered as a thin film consisting of multiple supermolecular complexes of one or more organic materials that are uniformly aligned in order to polarize light.

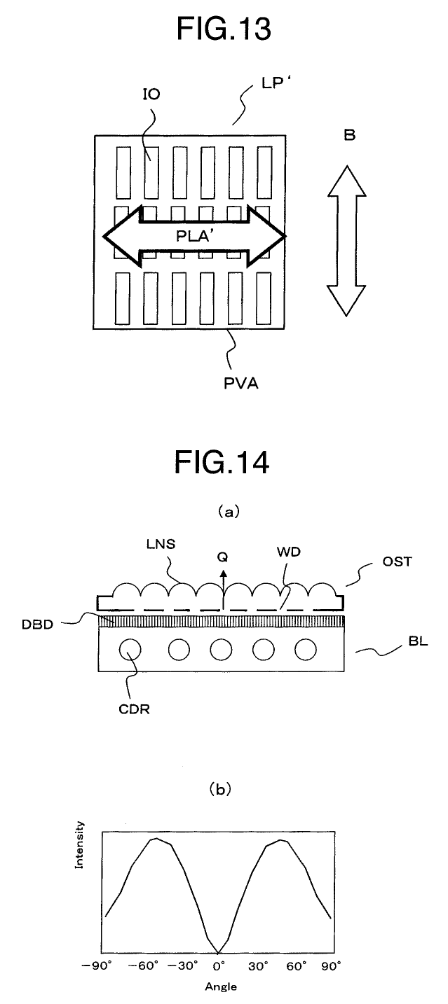

FIG. 13 shows a configuration of a polarizing plate which uses an O-type polarizer. The polarizing plate LP′ in FIG. 13 is formed by extending polyvinyl alcohol PVA colored with iodine IO in direction B in FIG. 13. In this case, the transmit axis PLA′ is perpendicular to direction B. It has been shown that the viewing angle characteristics of the polarizing plate LP′ having this configuration is not good compared with polarizing plates LP1 and LP2 using E-type polarizers described above.

While only polarizing plate LP1 has been described in the foregoing, polarizing plate LP2 formed on transparent substrate SUB2 has the same configuration as that of polarizing plate LP1. The transmit axes PLA1 and PLA2 of polarizing plate LP1 formed on transparent substrate SUB1 and polarizing plate LP2 formed on transparent substrate SUB2 are in a crossed-Nicol relation with each other as shown in FIG. 3.

The polarizing plates PL1 and PL2 described above are directly formed on one side of transparent substrates SUB1 and SUB2, respectively. However, the polarizing plates are not so limited. For example, a polarizing material may be applied onto one side of a film of polyethylene terephthalate (PET) or polyolefin to form an E-type polarizer and the polarizing plate with the film may be used as the polarizing plate PL1, PL2. If a polarizing plate is formed on a film having birefringence like a PET film, the problem of coloring can be avoided by placing the polarization plane on the panel side and the film on the outer side. If a polarizing plate is formed on a film that does not have birefringence or a phase difference, such as polyolefin, the film may be positioned on the panel side. If the polarizer material applied to such a film is soluble in water, the reliability of the application of the polarizer material can be ensured and the polarization performance can be improved by making the film surface hydrophilic using a UV cleaner called UV/O₃ cleaner.

Likewise, a polarizer material is applied onto one side of a film of triacetyl cellulose (TAC) to form an E-type polarizer and the polarizing plate with the film may be used as the polarizing plate PL1, PL2 described above. In this case, the film has a property that its surface can be readily made hydrophilic and therefore the reliability of application of the polarizer material can be ensured and the polarization performance can be improved. The polarizing plates PL1 and PL2 thus formed are attached to transparent substrates SUB1 and SUB2, respectively, in such a manner that the films are attached to the outer surface of the transparent substrates SUB1 and SUB2 and the E-type polarizers are positioned between the transparent substrates SUB1 and SUB2. This arrangement can prevent the anisotropy of the films from being impaired.

When the polarizing plates PL1 and PL2 having the films on which the polarizer material is applied is attached to the transparent substrates SUB1 and SUB2, respectively, the films may be attached onto the transparent substrates SUB1 and SUB2. In this case, a protective film may be formed on the polarizer material applied to the films to complete the polarizing plates PL1 and PL2. The polarizing plates PL1 and PL2 configured in this way are protected from external impacts by the protective film, thereby achieving a robust configuration. Similarly, a protective plate can be provided in front of the polarizing plates to protect the polarizers from external damage without forming a protective film.

Optical Sheet OST

FIG. 14A shows an embodiment in which an optical sheet OST having a large emission angle compared with an incidence angle is used as an optical sheet OST shown in FIG. 2. A backlight BL and a diffuser DBD are shown along with the optical sheet OST. FIG. 14A is a cross-sectional view taken along line VIII-VIII in FIG. 2.

The optical sheet OST includes a cluster of many convex lenses LNS which are semispherical projections on the surface of the optical sheet OST that faces the liquid crystal display panel PNL, and windows WD are formed at the bottoms of the convex lenses LNS on the backside of the optical sheet OST through which light can pass. For example, the windows WD can be formed by providing openings in a light shielding film formed on the backside of the optical sheet OST.

The optical sheet OST thus formed has a property that the intensity of light emitted from the backlight BL and passing through the optical sheet OST increases as the emission angle changes from 0 degrees to 45 degrees (−45 degrees) and decreases as the emission angle changes from 45 degrees (−45 degrees) to 90 degrees (−90 degrees), where the direction indicated by arrow Q in FIG. 14A is 0 degrees, as shown in the graph of FIG. 14B.

This means that the optical sheet OST having the configuration described above can significantly increase the emission angle of light that entered the liquid crystal display panel PNL from the backlight BL.

As has been described above, an liquid crystal display device according to the present invention uses a so-called in-plane switching mode liquid crystal display panel PNL which has good viewing angle characteristics and polarizing plates LP1 and LP2 using E-type polarizers which themselves have a good viewing angle, therefore the emission angle of light from the light source (concept including a backlight BL, diffuser DBD, and an optical sheet OST) is increased. In other words, the emission angle of light incident on the liquid crystal display panel PNL is increased in accordance with the wide viewing angle. The optical sheet described above, which controls the emission angle of incident light to a particular angle, may be a diffusion sheet that has a characteristic that causes incident light to be uniformly emitted substantially forward.

The optical sheet OST in the embodiment described above includes many lenses formed as semispherical projections. However, an optical sheet OST may be used that includes lenses that are semicylindrical projections extending in the x or y direction and are arranged side by side in the direction perpendicular to the direction of the length of the semicylindrical projections. This arrangement may be suitable for cases where it is desirable that the viewing angle should be large only in the x or y direction.

Other Embodiments of Locations of Polarizing Plates

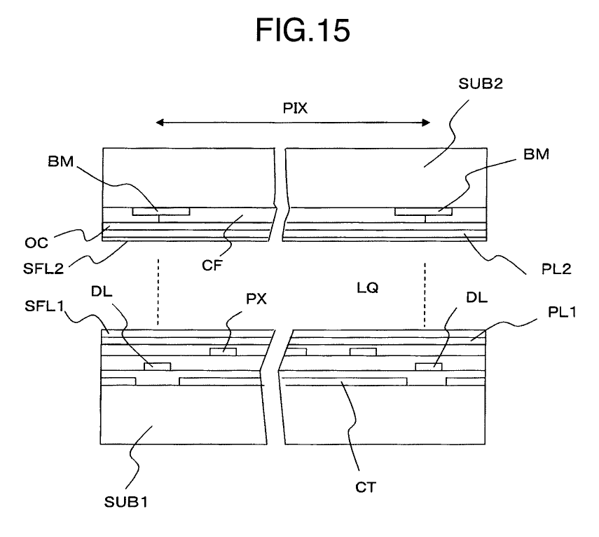

FIG. 15 shows a configuration of another embodiment of the liquid crystal display device described above and corresponds to FIG. 6.

Comparing with the configuration in FIG. 6, the configuration differs from the one shown in FIG. 6 in that polarizing plate PL1 is formed on the surface of transparent substrate SUB1 that faces a liquid crystal LQ and polarizing plate PL2 is formed on the surface of transparent substrate SB2 that faces the liquid crystal LQ.

Polarizing plate PL1 and PL2, each uses an E-type polarizer, can be formed significantly thin compared with polarizing plates that uses O-type polarizers, and accordingly can be easily contained in a liquid crystal display panel PNL.

This configuration also can avoid damage to polarizing plates PL1 and PL2 that would be caused by external impacts.

Polarizing plate PL1 in FIG. 15 is formed as a layer disposed closer to the liquid crystal than pixel electrodes PX. That is, a second protective film PSV2 which covers the pixel electrodes PX and also functions as a planarizing overcoat is formed and polarizing plate PL1 is formed on the top surface of the second protective film PSV2. A surface film SFL1 is formed so as to cover the polarizing plate PL1. The surface film SFL1 has a periodic structure on the surface facing the liquid crystal. Interaction of its interface with the liquid crystal LQ increases the force of the isotropic liquid crystal that holds the periodic structure and reduces alignment failures. However, polarizing plate PL1 is not limited to this configuration. The polarizing plate PL1 may be disposed closer to transparent substrate SUB1 than the pixel electrodes PX and counter electrodes CT.

Polarizing plate PL2 in FIG. 15 is formed as a layer disposed closer to the liquid crystal than color filters CF. That is, polarizing plate PL2 is formed on the top surface of the planarizing overcoat OC. A surface film SF2 having the same function as the surface film SFL1 is formed so as to cover the polarizing plate PL2. However, the polarizing plates are not limited to this configuration, as in the embodiments described above.

The surface film SFL1 and SFL2 having the function described above can be applied to other configurations as well. For example, they can be applied to the configuration shown in FIG. 6 as well, of course.

The liquid crystal display devices in the embodiments described above are so-called transmissive liquid crystal display devices. However, it will be understood that the present invention is applicable to liquid display devices called semi-transparent or reflective liquid crystal display devices as well. In those cases, the pixel electrodes PX or counter electrodes CT may be made of conductive materials that are opaque according to the types of the display devices. For example, in the case of a semi-transparent liquid crystal display device, the pixel electrodes PX may be made of a material having a good light reflection efficiency such as aluminum; in the case of a reflective liquid crystal display device, the counter electrode CT may be made of a material having a good light reflection efficiency such as aluminum.

The embodiments described above may be used independently or in combination. That is, the effects of the embodiments can be produced independently or synergistically.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display device comprising:
a first substrate and a second substrate;
a liquid crystal layer disposed between the first and second substrates;
a first electrode provided on the first substrate and a second electrode which applies an electric field to the liquid crystal layer by an electric potential difference produced between the first electrode and the second electrode; and
color filters provided on the first substrate or the second substrate;
wherein the liquid crystal layer has a property of changing from an optically isotropic state to an optically anisotropic state in response to application of a voltage; and
the color filters are made of a dye material.

2. The liquid crystal display device according to claim 1, wherein the dye material is a photosensitive material.

3. The liquid crystal display device according to claim 1, wherein a red color filter and a green color filter contain small particles or pigments.

4. The liquid crystal display device according to claim 1, wherein a red color filter contains small particles or pigments.

5. The liquid crystal display device according to claim 1, wherein the first and second electrodes comprise a sheet electrode formed on the first substrate and a set of electrodes formed over the electrode with an insulator formed over the electrode being provided between the electrode and the set of electrodes.

6. The liquid crystal display device according to claim 1, comprising a gate electrode, a thin film transistor which is turned on by a scanning signal from the gate electrode, a source electrode which supplies a video signal to one of the first and second electrodes through the turned-on thin film transistor, and a common electrode which supplies a reference signal which acts as a reference for the video signal to the other electrode of the first and second electrodes.

7. A liquid crystal display device comprising:
a first substrate and a second substrate;
a liquid crystal layer disposed between the first and second substrates;
a first electrode provided on the first substrate and a second electrode which applies an electric field to the liquid crystal layer by an electric potential difference produced between the first electrode and the second electrode; and
color filters provided on the first substrate or the second substrate;
wherein the liquid crystal layer has a property of changing from an optically isotropic state to an optically anisotropic state in response to application of a voltage; and
the color filters include at least a blue color filter made of a dye material.

8. The liquid crystal display device according to claim 7, wherein a green color filter is made of a dye material and a red color filter is made of a material in which pigments are distributed.

9. The liquid crystal display device according to claim 7, wherein a green color filter and a red color filter are made of a material in which pigments are distributed.

10. The liquid crystal display device according to claim 7, wherein the first and second electrodes comprise a sheet electrode formed on the first substrate and a set of electrodes formed over the electrode with an insulator formed over the electrode being provided between the electrode and the set of electrodes.

11. The liquid crystal display device according to claim 7, comprising: a gate electrode, a thin film transistor which is turned on by a scanning signal from the gate electrode, a source electrode which supplies a video signal to one of the first and second electrodes through the turned-on thin film transistor, and a common electrode which supplies a reference signal which acts as a reference for the video signal to the other electrode of the first and second electrodes.

12. A liquid crystal display device comprising:
a first substrate and a second substrate;
a liquid crystal layer disposed between the first and second substrates;
a first electrode provided on the first substrate and a second electrode which applies an electric field to the liquid crystal layer by an electric potential difference produced between the first electrode and the second electrode; and
color filters provided on the second substrate;
wherein the liquid crystal layer has a property of changing from an optically isotropic state to an optically anisotropic state in response to application of a voltage; and
the color filters include at least a blue color filter made of a dye material.

13. The liquid crystal display device according to claim 12, wherein a green color filter and a red color filter are made of a dye material.

14. The liquid crystal display device according to claim 12, wherein a green color filter is made of a dye material and a red color filter is made of a material in which pigments are distributed.

15. The liquid crystal display device according to claim 12, wherein a green color filter and a red color filter are made of a material in which pigments are distributed.

16. The liquid crystal display device according to claim 12, wherein the first and second electrodes comprise a sheet electrode formed on the first substrate and a set of electrodes formed over the electrode with an insulator formed over the electrode being provided between the electrode and the set of electrodes.

17. The liquid crystal display device according to claim 12, comprising a gate electrode, a thin film transistor which is turned on by a scanning signal from the gate electrode, a source electrode which supplies a video signal to one of the first and second electrodes through the turned-on thin film transistor, and a common electrode which supplies a reference signal which acts as a reference for the video signal to the other electrode of the first and second electrodes.

18. The liquid crystal display device according to claim 1, comprising:
a first substrate and a second substrate;
a polarizing plate provided on the first substrate and the second substrate;
a liquid crystal layer disposed between the first and second substrates; and
a first electrode provided on the first substrate and a second electrode which applies an electric field to the liquid crystal layer by an electric potential difference produced between the first electrode and the second electrode;
wherein the liquid crystal layer has a property of changing from an optically isotropic state to an optically anisotropic state in response to application of a voltage; and
the polarizing plate comprises an E-type polarizer or polarizer with an extraordinary transmit axis.

19. The liquid crystal display device according to claim 18, wherein the polarizing plate is formed on a surface of each of the first substrate and the second substrate opposite the liquid crystal layer.

20. The liquid crystal display device according to claim 19, wherein the polarizing plate is protected by a protective film or a protective plate.

21. The liquid crystal display device according to claim 19, wherein the polarizing plate is formed by applying an E-type polarizer onto a film surface.

22. The liquid crystal display device according to claim 18, wherein the polarizing plate is formed on a surface of each of the first substrate and the second substrate that faces the liquid crystal.

23. The liquid crystal display device according to claim 1, comprising a liquid crystal display panel and a backlight disposed at the rear of the liquid crystal panel with an optical sheet being provided between the liquid crystal panel and the backlight, wherein the liquid crystal display panel comprises a first substrate, a second substrate, a polarizing plate provided on each of the first and second substrates, a liquid crystal layer disposed between the first and second substrates, a first electrode provided on the first substrate, and a second electrode which applies an electric field to the liquid crystal layer by an electric potential difference produced between the first electrode and the second electrode;
the liquid crystal layer has a property of changing from an optically isotropic state to an optically anisotropic state in response to application of a voltage;
the polarizing plate is formed by an E-type polarizer; and
the optical sheet is formed so that an emission angle of outgoing light traveling to the liquid crystal display panel is increased with respect to incident light from the backlight.

24. The liquid crystal display device according to claim 23, wherein the polarizing plate is formed on a surface of each of the first substrate and the second substrate opposite the liquid crystal layer.

25. The liquid crystal display device according to claim 8, wherein the polarizing plate is formed on a surface of each of the first substrate and the second substrate that faces the liquid crystal.

26. The liquid crystal display device according to claim 23, wherein the first and second electrodes comprise a sheet electrode formed on the first substrate and a set of electrodes formed over the electrode with an insulator formed over the electrode being provided between the electrode and the set of electrodes.

27. The liquid crystal display device according to claim 23, wherein the optical sheet comprises a cluster of convex lenses formed on a surface facing the liquid crystal display panel, and windows capable of transmitting light formed on the backside at bottoms of the convex lenses, the windows being capable of transmitting light.
